(19) United States
(12) Patent Application Publication
(10) Pub. No.: US 2013/0243204 A1
(43) Pub. Date: Sep. 19, 2013

(54) SOUND QUALITY TESTING METHOD AND SYSTEM

(71) Applicants: CHUN-WEI KAO, TAIPEI CITY (TW); LIANG-CHI HOU, NEW TAIPEI CITY (TW); TAI-JU CHIANG, NEW TAIPEI CITY (TW); CHING-FENG HSIEH, TAIPEI CITY (TW)

(72) Inventors: CHUN-WEI KAO, TAIPEI CITY (TW); LIANG-CHI HOU, NEW TAIPEI CITY (TW); TAI-JU CHIANG, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/474,857

(22) Filed: May 18, 2012

(30) Foreign Application Priority Data
Mar. 16, 2012 (TW) 101109088

(51) Int. Cl. H04R 29/00

(52) U.S. Cl. 381/56

(57) ABSTRACT

A sound quality testing method and system test sound quality of a network-based communication device. The method includes connecting the network-based communication device to a test host through the Internet; sending a testing signal from the test host to the sound receiving unit for generating an audio packet signal; sending the audio packet signal from the sound receiving unit to the test host through the Internet to produce a first test result; sending a test packet signal from the test host to the network-based communication device through the Internet to enable the network-based communication device to generate a speaker signal; receiving and analyzing the speaker signal by the test host to produce a second test result; and evaluating sound quality of the network-based communication device by the test host based on the first test result and the second test result.

### CROSS-REFERENCE TO RELATED APPLICATION

This non-provisional application claims priority under 35 U.S.C. §119(a) on Patent Application No(s). 101109088 filed in Taiwan, R.O.C. on Mar. 16, 2012, the entire contents of which are hereby incorporated by reference.

### FIELD OF TECHNOLOGY

The present invention relates to sound quality testing methods and systems, and more particularly, to a sound quality testing method and system for testing and determining whether a sound generating unit and a sound receiving unit of a network-based communication device comply with a predetermined audio rule.

### BACKGROUND

After a conventional network-based communication device, such as a handheld electronic device, a Voice over Internet Protocol (VoIP), or a public switched telephone network (PSTN) phone, has been manufactured at the production end, a quality control (QC) worker tests the sound receiving and sound generating functions of the communication device.

A conventional testing method requires the quality control worker to perform conversation between two network-based communication devices and confirm manually whether a loudspeaker and a microphone of the network-based communication devices is functioning well. However, in practice, the quality control worker is unable to test and evaluate precisely the sound quality based on the loudspeaker and the microphone.

The sound quality of the loudspeakers and microphones of network-based communication devices is governed by international standard audio rules (such as TIA 810B, TIA920, ETSI 202 737, ETSI 202 738, ETSI 202 739 or ETSI 202 740) whereby products manufactured by different manufacturers are compatible. However, it is impossible for the aforesaid conventional testing method to determine whether the sound quality complies with the international standard audio rules.

Accordingly, the present invention puts forth a sound quality testing method and system with a view to overcoming the aforesaid drawbacks of the prior art, speeding up a sound quality test, and enhancing the stability of the sound quality test.

### SUMMARY

It is an objective of the present invention to provide a sound quality testing method to simulate how a user operates a network-based communication device and thereby test a sound generating unit and a sound receiving unit of the network-based communication device.

Another objective of the present invention is to provide the sound quality testing method for evaluating the sound quality of the network-based communication device in terms of volume, frequency response, harmonic wave distortion, and sensitivity to determine whether the sound quality of the network-based communication device complies with a user-defined audio rule or an international standard audio rule.

Yet another objective of the present invention is to provide a sound quality testing system comprising a test host, a sound source unit, and a receiver unit so as to perform an accurate and stable test on the sound quality of a sound generating unit and a sound receiving unit of a network-based communication device.

In order to achieve the above and other objectives, the present invention provides a sound quality testing method for testing sound quality of a sound generating unit and a sound receiving unit of a network-based communication device, the method comprising the steps of: connecting the network-based communication device to a test host through the Internet; configuring and storing a standard audio signal by the test host and sending a testing signal from a sound source unit based on the standard audio signal; generating an audio packet signal by a sound receiving unit based on the testing signal received and sending the audio packet signal to the test host through the Internet to allow the test host to analyze the audio packet signal and the standard audio signal for generating a first test result; formatting the standard audio signal into a packet by the test host so as to generate a test packet signal and sending the test packet signal to the network-based communication device through the Internet; generating a speaker signal by the sound generating unit of the network-based communication device based on the test packet signal; receiving the speaker signal by a receiver unit and sending the speaker signal from the receiver unit to the test host so as for the test host to analyze the speaker signal and the standard audio signal and generate the second test result; and evaluating the sound quality of the sound generating unit and the sound receiving unit of the network-based communication device based on the first test result and the second test result.

In order to achieve the above and other objectives, the present invention further provides a sound quality testing system for testing and determining whether an audio packet signal of a sound receiving unit and a speaker signal of a sound generating unit of a network-based communication device comply with a preset audio rule, the network-based communication device transmitting the audio packet signal through the Internet, the system comprising: a test host for storing a standard audio signal, generating a testing signal according to the standard audio signal, receiving the audio packet signal of the network-based communication device, and confirming that the network-based communication device complies with the preset audio rule when the audio packet signal and the speaker signal conform with the standard audio signal; a sound source unit disposed between the test host and a sound receiving unit and adapted to send the testing signal; and a receiver unit disposed between the test host and the sound generating unit and adapted to send the speaker signal to the test host after receiving the speaker signal.

A sound quality testing method and system of the present invention use a test host to supply a test packet signal to a network-based communication device, receive a speaker signal from a sound generating unit (such as a loudspeaker) of the network-based communication device, and supply a testing signal to a sound receiving unit (such as microphone) of the network-based communication device so as for the network-based communication device to convert the testing signal into an audio packet signal. The audio packet signal is sent to the test host through the Internet. The test host analyzes the sound quality of the network-based communication device based on a speaker signal received and the audio packet signal.

Compared with the prior art, the present invention provides a sound quality testing method and system to overcome a drawback of the prior art, that is, the prior art discloses that only a simple easy test can be performed on a network-based communication device to evaluate damage done to a component, such as a loudspeaker or a microphone, of the network-based communication device. Furthermore, with the sound quality testing method and system of the present invention, a precise test can be performed on the sound quality of a sound generating unit and a sound receiving unit of the network-based communication device so as to determine whether the sound quality complies with a user-defined audio rule or an international standard audio rule (such as a sound quality standard rule for TIA 810B, TIA920, ETSI 202 737, ETSI 202 738, ETSI 202 739 or ETSI 202 740.)

### BRIEF DESCRIPTION

Objectives, features, and advantages of the present invention are hereunder illustrated with specific embodiments in conjunction with the accompanying drawings, in which:

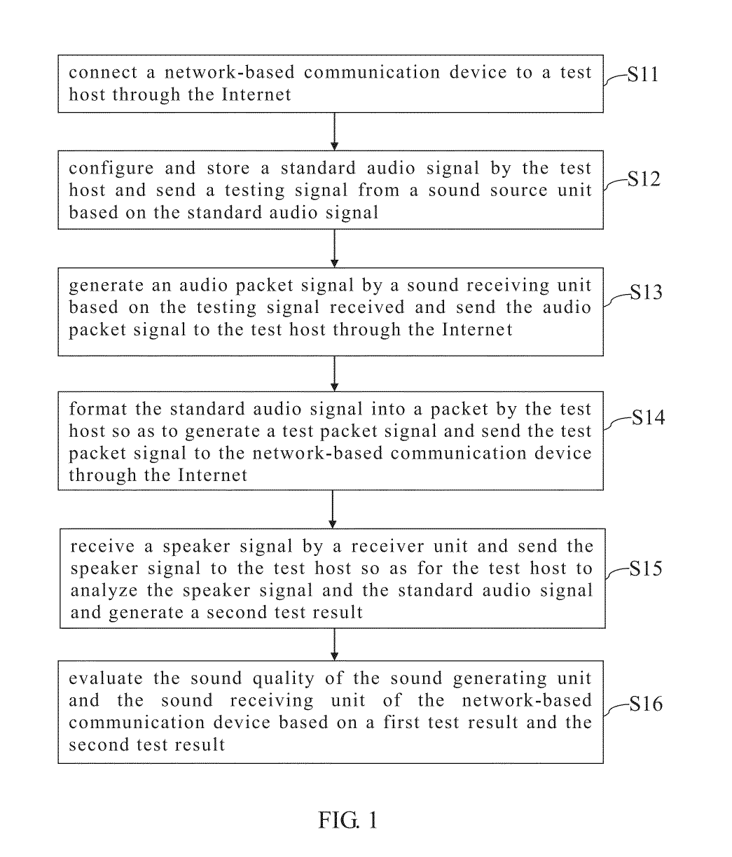

FIG. 1 is a flow chart of a sound quality testing method according to an embodiment of the present invention;

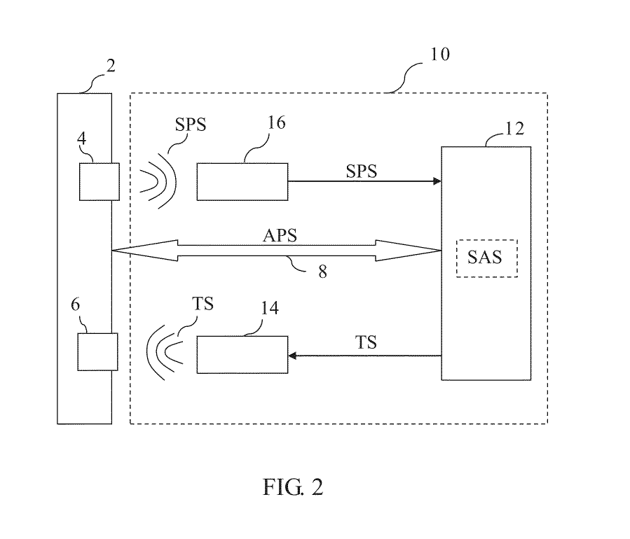

FIG. 2 is a block diagram of a sound quality testing system according to the first embodiment of the present invention; and

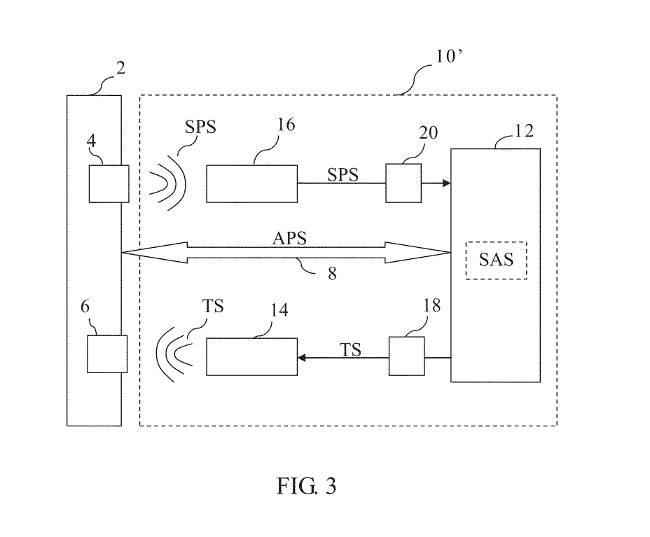

FIG. 3 is a block diagram of a sound quality testing system according to the second embodiment of the present invention.

### DETAILED DESCRIPTION

Referring to FIG. 1, there is shown a flow chart of a sound quality testing method according to an embodiment of the present invention. As shown in FIG. 1, the sound quality testing method is intended for testing the sound quality of a sound generating unit and a sound receiving unit of a network-based communication device. The network-based communication device is a Voice over Internet Protocol (VoIP) operating in a hand-free mode or a public switched telephone network (PSTN) phone. The sound generating unit is a loudspeaker. The sound receiving unit is a microphone. The sound quality is assessed in terms of volume, frequency response, harmonic wave distortion, and sensitivity.

The process flow of the sound quality testing method starts with step S11. Step S11 involves connecting the network-based communication device to a test host through the Internet. In step S11, the connection between the network-based communication device and another network-based communication device (i.e., the test host) through the Internet is simulated. An application related to VoIP is installed on the test host in advance to create an environment in which a user simulates two-way voice communication with the network-based communication device.

Step S12 involves configuring and storing a standard audio signal in the test host and sending from a sound source unit a testing signal based on the standard audio signal. In this step, the standard audio signal is stored in the test host in advance and intended to serve as a basis of evaluation during the sound quality testing process. The standard audio signal is configured by a user independently or is any signal that complies with international standard audio rules, such as TIA 810B, TIA920, ETSI 202 737, ETSI 202 738, ETSI 202 739 or ETSI 202 740. The test host sends the testing signal based on the standard audio signal for testing the network-based communication device.

Since the testing signal generated from the test host is a digital signal format, it is useless to provide the testing signal in a digital signal format to a sound source unit that can be driven by a testing signal in an analog signal format only. Hence, it is feasible to convert the testing signal from a digital signal format to an analog signal format and send the resultant testing signal in an analog signal format to the sound receiving unit. The sound source unit is an artificial mouth or a loudspeaker, for example.

The sound source unit is positioned proximate to the sound receiving unit of the network-based communication device, such that the testing signal is sent to the sound receiving unit in an undistorted manner.

Step S13 involves generating an audio packet signal by the sound receiving unit based on the testing signal received and sending the audio packet signal to the test host through the Internet to allow the test host to analyze the audio packet signal and the standard audio signal for generating a first test result. In step S13, the audio packet signal is in the form of a packet that can be transmitted through the Internet. The test host receives the audio packet signal from the network-based communication device through the Internet. Afterward, the test host analyzes the audio packet signal and retrieves the testing signal previously received by the sound receiving unit. Hence, the test host acquires data related to the sound quality to be evaluated in terms of volume, frequency response, harmonic wave distortion, and sensitivity, by analyzing the testing signal carried by the audio packet signal, and then compares the data with the standard audio signal so as to generate the first test result.

Step S14 involves formatting the standard audio signal into a packet by the test host so as to generate a test packet signal and sending the test packet signal to the network-based communication device through the Internet. In step S14, the test host formats the standard audio signal into a packet so as to generate the test packet signal, and the sound generating unit of the network-based communication device generates a speaker signal based on the test packet signal. Hence, after the network-based communication device has received the test packet signal, the sound generating unit generates a speaker signal.

Step S15 involves receiving the speaker signal by a receiver unit and sending the speaker signal to the test host to analyze the speaker signal and the standard audio signal and generate the second test result. In step S15, the test host receives the speaker signal generated from the network-based communication device, analyzes the sound quality of the speaker signal in terms of volume, frequency response, harmonic wave distortion, and sensitivity, and compares the result of the analysis with the standard audio signal so as to generate the second test result.

In another embodiment, with the speaker signal being in an analog signal format, the test host cannot receive the speaker signal in the analog signal format; hence, it is feasible to convert the speaker signal from an analog signal format into a digital signal format.

The test host receives the speaker signal in an analog signal format through a receiver unit connected to the test host. For example, the receiver unit is an artificial ear or a microphone. The receiver unit is positioned proximate to the sound generating unit of the network-based communication device so as for the receiver unit to receive the speaker signal in an undistorted manner.

Step S16 involves evaluating the sound quality of the sound generating unit and the sound receiving unit of the network-based communication device based on the first test result and the second test result. In step S16, the test host determines whether the sound generating unit and the sound receiving unit of the network-based communication device meet the requirements of standard signals, by making reference to the first test result and the second test result, so as to determine whether the network-based communication device is a conforming product or a non-conforming product.

The aforesaid sequence of the steps of the testing method is illustrative rather than restrictive of the present invention. That is to say, it is feasible that the testing method involves testing the sound generating unit or the sound receiving unit of the network-based communication device first.

Referring to FIG. 2, there is shown a block diagram of a sound quality testing system 10 according to the first embodiment of the present invention. As shown in FIG. 2, the sound quality testing system 10 tests and determines whether the audio packet signal APS of a sound receiving unit 6 and a speaker signal SPS of the sound generating unit 4 of the network-based communication device 2 conform with the definition of a standard audio signal SAS set forth in a preset audio rule, wherein the network-based communication device 2 transmits the audio packet signal APS through the Internet 8. For example, the network-based communication device 2 is a Voice over Internet Protocol (VoIP) operating in a hand-free mode or a public switched telephone network (PSTN) phone. The sound generating unit is a loudspeaker. The sound receiving unit is a microphone. The preset audio rule is a user-defined rule or a sound quality standard rule that complies with TIA 810B, TIA920, ETSI 202 737, ETSI 202 738, ETSI 202 739 or ETSI 202 740. For example, the connection to the Internet 8 is cable connection or wireless connection.

The sound quality testing system 10 comprises the test host 12, a sound source unit 14, and a receiver unit 16.

The test host 12 stores the standard audio signal SAS. The test host 12 is connected to the network-based communication device 2 through the Internet 8. The test host 12 generates and sends a testing signal TS to the sound source unit 14 based on the standard audio signal SAS, and receives the audio packet signal APS from the network-based communication device 2. The test host 12 analyzes and compares the audio packet signal APS, the speaker signal SPS, and a standard signal SS in terms of the sound quality thereof, so as to determine whether the network-based communication device complies with the preset audio rule.

The sound source unit 14 is disposed between the test host 12 and the sound receiving unit 6. The sound source unit 14 is connected to the test host 12. The testing signal TS drives the sound source unit 14. The testing signal TS is sent to the sound receiving unit 6. The sound source unit 14 is positioned proximate to the periphery of the sound receiving unit 6, such that the testing signal TS is sent to the sound receiving unit 6 in an accurate and undistorted manner. The sound source unit 14 is an artificial mouth or a loudspeaker.

The receiver unit 16 is disposed between the test host 12 and the sound generating unit 4. The receiver unit 16 is connected to the test host 12. After receiving the speaker signal SPS, the receiver unit 16 sends the speaker signal SPS to the test host 12. The receiver unit 16 is positioned proximate to the periphery of the sound generating unit 4, such that the speaker signal SPS is received by the receiver unit 16 in an accurate and undistorted manner. The receiver unit 16 is an artificial ear or a microphone.

Referring to FIG. 3, there is shown a block diagram of a sound quality testing system 10′ according to the second embodiment of the present invention. As shown in FIG. 3, the sound quality testing system 10′ tests and determines whether the audio packet signal APS of the sound receiving unit 6 and the speaker signal SPS of the sound generating unit 4 of the network-based communication device 2 conform with the definition of a standard audio signal SAS set forth in a preset audio rule. The sound quality testing system 10′ comprises the test host 12, the sound source unit 14, and the receiver unit 16. The sound quality testing system 10′ in the second embodiment is distinguished from the sound quality testing system 10 in the first embodiment in that the sound quality testing system 10′ in the second embodiment further comprises a digital-to-analog conversion unit 18 and an analog-to-digital conversion unit 20.

The digital-to-analog conversion unit 18 is disposed between the test host 12 and the sound source unit 14 and adapted to convert the testing signal TS from a digital signal format into an analog signal format. The analog-to-digital conversion unit 20 is disposed between the test host 12 and the receiver unit 16 and adapted to convert the speaker signal SPS from an analog signal format into a digital signal format.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A sound quality testing method for testing sound quality of a sound generating unit and a sound receiving unit of a network-based communication device, the method comprising the steps of:
A: connecting the network-based communication device to a test host through the Internet;
B: configuring and storing a standard audio signal by the test host and sending a testing signal from a sound source unit based on the standard audio signal;
C: generating an audio packet signal by a sound receiving unit based on the testing signal received and sending the audio packet signal to the test host through the Internet to allow the test host to analyze the audio packet signal and the standard audio signal for generating a first test result;
D: formatting the standard audio signal into a packet by the test host so as to generate a test packet signal and sending the test packet signal to the network-based communication device through the Internet;
E: generating a speaker signal by the sound generating unit of the network-based communication device based on the test packet signal;
F: receiving the speaker signal by a receiver unit and sending the speaker signal from the receiver unit to the test host so as for the test host to analyze the speaker signal and the standard audio signal and generate the second test result; and
G: evaluating the sound quality of the sound generating unit and the sound receiving unit of the network-based communication device based on the first test result and the second test result.

2. The sound quality testing method of claim 1, wherein step B further comprises the sub-step of converting the testing signal sent from the sound source unit from a digital signal format into an analog signal format.

3. The sound quality testing method of claim 2, wherein the testing signal is sent to the sound source unit connected to the test host, and the testing signal drives the sound source unit, thereby allowing the testing signal to be sent to the sound receiving unit.

4. The sound quality testing method of claim 1, wherein step F further comprises the sub-step of converting the speaker signal from an analog signal format into a digital signal format before the speaker signal is sent to the test host.

5. The sound quality testing method of claim 4, wherein the speaker signal is sent to the receiver unit connected to the test host so as for the test host to receive the speaker signal through the receiver unit.

6. A sound quality testing system for testing and determining whether an audio packet signal of a sound receiving unit and a speaker signal of a sound generating unit of a network-based communication device comply with a preset audio rule, the network-based communication device transmitting the audio packet signal through the Internet, the system comprising:
a test host for storing a standard audio signal, generating a testing signal according to the standard audio signal, receiving the audio packet signal of the network-based communication device, and confirming that the network-based communication device complies with the preset audio rule when the audio packet signal and the speaker signal conform with the standard audio signal;
a sound source unit disposed between the test host and a sound receiving unit and adapted to send the testing signal; and
a receiver unit disposed between the test host and the sound generating unit and adapted to send the speaker signal to the test host after receiving the speaker signal.

7. The sound quality testing system of claim 6, further comprising a digital-to-analog conversion unit disposed between the test host and the sound source unit for converting the testing signal from a digital signal format into an analog signal format.

8. The sound quality testing system of claim 6, further comprising an analog-to-digital conversion unit disposed between the test host and the receiver unit for converting the speaker signal from an analog signal format into a digital signal format.

9. The sound quality testing system of claim 6, wherein the sound source unit is one of an artificial mouth and a loudspeaker, wherein the receiver unit is one of an artificial ear and a microphone.

10. The sound quality testing system of claim 6, wherein the preset audio rule conforms with a sound quality standard rule of TIA 810B, TIA920, ETSI 202 737, ETSI 202 738, ETSI 202 739 or ETSI 202 740.
